(19) United States
(12) Patent Application Publication
(10) Pub. No.: US 2026/0032566 A1
(43) Pub. Date: Jan. 29, 2026

(54) BLUETOOTH COMMUNICATION METHOD AND REMOTE CONTROLLER DEVICE

(71) Applicant: Realtek Semiconductor Corporation, Hsinchu (TW)

(72) Inventors: YuShun LIU, Jiangsu Province (CN); ChenJie JIN, Jiangsu Province (CN); Hao CHONG, Jiangsu Province (CN); XiaoWei BIAN, Jiangsu Province (CN)

(21) Appl. No.: 19/260,641

(22) Filed: Jul. 7, 2025

(30) Foreign Application Priority Data
Jul. 25, 2024 (CN) 202411009814.1

(51) Int. Cl. H04W 48/16; H04W 4/80; H04W 48/10; H04W 76/19

(52) U.S. Cl. CPC H04W 48/16; H04W 4/80; H04W 48/10; H04W 76/19

(57) ABSTRACT

A Bluetooth communication method is suitable for a remote controller device. The remote controller device is configured to be Bluetooth-paired with a host terminal. The Bluetooth communication method includes following steps. In a lasting duration since the remote controller device resumes from a power-off mode into a power-on mode and a Bluetooth connection is not yet re-established between the remote controller device and the host terminal, key-input information generated by the remote controller device is temporarily recorded in a buffer memory of the remote controller device. The key-input information temporarily recorded in the buffer memory is attached to a payload of a re-connection advertising packet. The re-connection advertising packet is transmitted, and the re-connection advertising packet is configured to trigger re-establishing of the Bluetooth connection between the remote controller device and the host terminal.

### CROSS-REFERENCE TO RELATED APPLICATION

This application claims priority to Chinese Application Serial Number 202411009814.1, filed Jul. 25, 2024, which is herein incorporated by reference in its entirety.

### BACKGROUND

### Field of Invention

The disclosure relates to a Bluetooth communication method and a remote controller device. More particularly, the disclosure relates to a Bluetooth communication method and a remote controller device using re-connection advertising packets to rapidly transmit information.

### Description of Related Art

Directed advertising packet of Bluetooth, which is one kind of advertising packets in the Bluetooth Low Energy (BLE) field, is used for rapid re-connection between devices, and it is also known as re-connection advertising packet.

Directed advertising (re-connection advertising) allows a device to transmit advertising packets to a specific target device but not to all possible receiving devices. The directed advertising is often adopted under the condition of rapid re-connection. For example, when the connection between the Bluetooth device (e.g., Bluetooth remote controller) and the host terminal (e.g., smart TV, smartphone, tablet computer or laptop computer) is disconnected, the Bluetooth device or the host terminal is capable of recovering the connection by the directed advertising. The directed advertising of Bluetooth can improve the efficiency for re-connection of the devices and the reliability, so that it is especially suitable for the application scenario requiring frequent disconnections and re-connections.

### SUMMARY

The disclosure provides a Bluetooth communication method for a remote controller device. In some embodiments, the Bluetooth communication method comprises the following steps: in a lasting duration since the remote controller device resumes from a power-off mode into a power-on mode and the remote controller device does not re-establish a Bluetooth connection with the host terminal yet, temporarily recording a key-input information generated by the remote controller device in a buffer memory of the remote controller device; attaching the key-input information in the buffer memory to a payload of a re-connection advertising packet; and, transmitting the re-connection advertising packet, and the re-connection advertising packet being configured to trigger re-establishing of the Bluetooth connection between the remote controller device and the host terminal.

The disclosure also provides a remote controller device. In some embodiments, the remote controller device includes a Bluetooth communication circuit, a buffer memory, a key module and a processing unit. The Bluetooth communication circuit is configured to Bluetooth-pair the remote controller device and a host terminal. The processing unit is coupled to the Bluetooth communication circuit, the buffer memory and the key module. Wherein, in a lasting duration since the remote controller device resumes from a power-off mode into a power-on mode and the remote controller device does not re-establish a Bluetooth connection with the host terminal yet, the processing unit temporarily records a key-input information is generated by the key module in the buffer memory. The processing unit attaches the key-input information in the buffer memory to a payload of a re-connection advertising packet. The Bluetooth communication circuit is configured to transmit the re-connection advertising packet, and the re-connection advertising packet is configured to trigger re-establishing of the Bluetooth connection between the remote controller device and the host terminal.

The disclosure also provides a Bluetooth communication method for a wireless communication system including a host terminal and a remote controller device Bluetooth-paired with each other. In some embodiments, the Bluetooth communication method comprises the following steps: in a lasting duration since the remote controller device resumes from a power-off mode into a power-on mode and the remote controller device does not re-establish a Bluetooth connection with the host terminal yet, the remote controller device temporarily recording a key-input information generated by the remote controller device in the buffer memory of the remote controller device; the remote controller device attaching the key-input information in the buffer memory to a payload of a re-connection advertising packet; the remote controller device transmitting the re-connection advertising packet, and the re-connection advertising packet being configured to trigger re-establishing of the Bluetooth connection between the remote controller device and the host terminal; the host terminal receiving the re-connection advertising packet; the host terminal re-establishing the Bluetooth connection with the remote controller device according to the re-connection advertising packet; and, the host terminal executing a corresponding operation according to the key-input information attached to the payload of the re-connection advertising packet.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a wireless communication system according to some embodiments of the disclosure.

FIG. 2 is a flow chart illustrating a Bluetooth communication method according to the disclosure.

FIG. 3 is a schematic diagram illustrating the packet content of a re-connection advertising packet according to some embodiments of the disclosure.

FIG. 4A to FIG. 4E are schematic diagrams respectively illustrating various key-input information, corresponding to different keys pressed by the user, carried by the re-connection advertising packet.

FIG. 5 is a flow chart illustrating the steps executed by the host terminal of a Bluetooth communication method according to the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

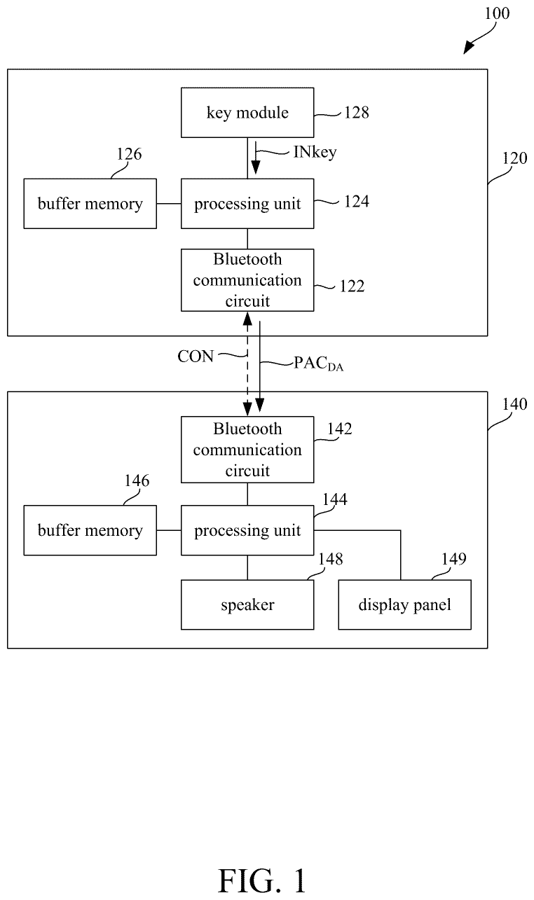

Reference is made to FIG. 1, which is a schematic diagram illustrating a wireless communication system 100 according to some embodiments of the disclosure. The wireless communication system 100 includes a remote controller device 120 and a host terminal 140. For example, the host terminal 140 can be an electronic device such as smart TV, smartphone, tablet computer or laptop computer. The remote controller device 120 is configured to remotely control the host terminal 140 to execute various operations.

Taking a smart TV as an example of the host terminal 140 in the embodiment of FIG. 1, the host terminal 140 can include a Bluetooth communication circuit 142, a processing unit 144, a buffer memory 146, a speaker 148 and a display panel 149. The remote controller device 120 is Bluetooth-paired with the smart TV (host terminal 140), and the remote controller device 120 is configured to remotely control the functions of the smart TV. As shown in FIG. 1, the controller device 120 includes a key module 128, and the key module 128 can include various function keys (e.g., sound volume increase key, sound volume decrease key, switch key, mute key, home key, directional keys, and execute/cancel keys). According to different keys pressed by the user, the key module 128 would correspondingly generate an input information INkey to remotely control the smart TV to execute the functions of increasing the sound volume, decreasing the sound volume, switching on/off the power, muting, and returning to the home menu.

However, the host terminal 140 and the remote controller device 120 are not limited to the smart TV and the TV controller in this disclosure. In practice, the host terminal 140 can be an electronic device such as smartphone, tablet computer or laptop computer, and the remote controller device 120 can remotely control the various electronic devices to execute different functions (e.g., answering phone, taking picture, launching application program, and selecting file).

As shown in the embodiment in FIG. 1, the remote controller device 120 includes a Bluetooth communication circuit 122, a processing unit 124, a buffer memory 126 and the key module 128. The processing unit 124 is coupled to the Bluetooth communication circuit 122, the buffer memory 126 and the key module 128. The Bluetooth communication circuit 122 is configured to Bluetooth-pair the remote controller device 120 and the host terminal 140, i.e., establish a Bluetooth connection CON between the Bluetooth communication circuit 122 of the remote controller device 120 and the Bluetooth communication circuit 142 of the host terminal 140, so as to transmit various information and orders between the remote controller device 120 and the host terminal 140 through the Bluetooth connection CON.

In one embodiment, the processing unit 124 can include a processor, a System on a Chip (SoC), a microcontroller (MCU) or an Application-Specific Integrated Circuit (ASIC). The buffer memory 126 can include a dynamic random-access memory, a cache memory or a flash memory. The key module 128 can include one or more mechanical keys, touch keys, capacitive keys or micro switches.

In practice, for the purposes of saving power and prolonging the battery life of the remote controller device 120, the remote controller device 120 would turn into the power-off mode if the user has not operated the remote controller device 120 for a while. At this time, the Bluetooth connection CON between the remote controller device 120 and the host terminal 140 would be cut off. When the user operates the remote controller device 120 again and the remote controller device 120 resumes from the power-off mode into the power-on mode, the remote controller device 120 and the host terminal 140 can rapidly recover and re-establish the Bluetooth connection CON by the re-connection advertising packet, which is also known as directed advertising packet.

Typical re-connecting process is described as follows. The remote controller device 120 transmits the re-connection advertising packet, and the content of the re-connection advertising packet includes an initiator address of the remote controller device 120 and a advertising target address of the host terminal 140. After receiving the re-connection advertising packet and confirming the addresses matching, the host terminal 140 transmits a connection request packet to the remote controller device 120. After that, the remote controller device 120 and the host terminal 140 execute handshaking according to the Bluetooth protocol to establish a stable Bluetooth connection CON. Afterward, the remote controller device 120 transmits the key-input information to the host terminal 140 through the re-established Bluetooth connection CON.

However, in an application scenario requiring real-time response, for example, the user using the remote controller device 120 to adjust the sound volume of television or to switch on/off the television, the response time may be too long if the key press information input by the user (e.g., pressing) is transmitted after the re-connection advertising, handshaking and establishing the Bluetooth connection CON between the devices. The user may assume that the previous press input failed and then repeat pressing, causing the input confusion to reduce the user experience quality. Besides, if the Bluetooth connection CON cannot be successfully re-established due to serious noise disturbance in the surrounding, it may cause the loss of the key information to be transmitted.

The disclosure provides a Bluetooth communication method to attach the key-input information INkey to a payload of a re-connection advertising packet PAC_{DA} to directly carry the key-input information INkey by the re-connection advertising packet PAC_{DA}. Once the host terminal 140 receives the re-connection advertising packet PAC_{DA}, it can directly analyze and respond to the key-input information INkey without waiting for the re-establishing of the Bluetooth connection CON. Thereby, the response speed of the wireless communication system 100 can be increased, the influence of the noise disturbance can be reduced, and the user experience can be improved.

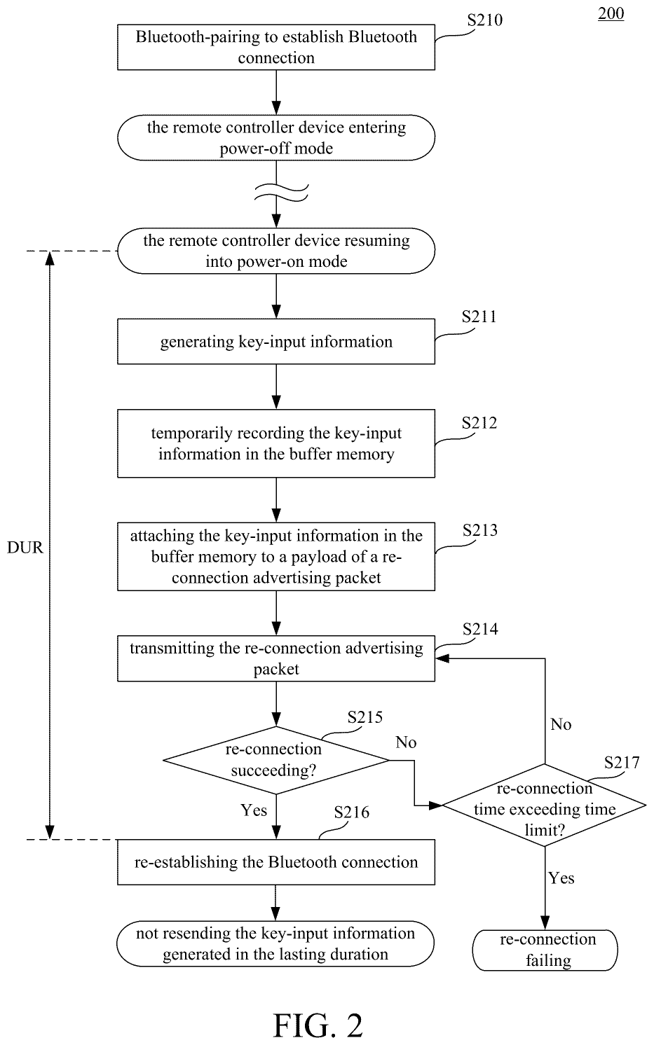

Reference is made to FIG. 2, which is a flow chart illustrating a Bluetooth communication method 200 according to the disclosure. The Bluetooth communication method 200 shown in FIG. 2 includes step S210 to step S217, which can be executed by the remote controller device 120 in FIG. 1.

As shown in FIG. 1 and FIG. 2, the Bluetooth communication circuit 122 of the remote controller device 120 executes the step S210 to Bluetooth-pair the remote controller device 120 with the host terminal 140 and establish the Bluetooth connection CON. In practice (for example, the user does not operate the remote controller device 120 for a while), the remote controller device 120 enters the power-off mode, and the Bluetooth communication circuit 122 does not keep the Bluetooth connection CON in the power-off mode to decrease the power consumption. For example, the remote controller device 120 can stop providing power to the Bluetooth communication circuit 122 but merely provide basic power to the processing unit 124, the buffer memory 126 and the key module 128.

Afterward, the remote controller device 120 resumes from the power-off mode into the power-on mode if the user presses the key module 128 again. At this time, the remote controller device 120 just resumes into the power-on mode but still not re-establishes the Bluetooth connection CON with the host terminal 140, and the key module 128 executes the step S211 to sense the operation of the user and generate the key-input information INkey, and transmit the key-input information INkey to the processing unit 124.

In this lasting duration DUR (from the time of the remote controller device 120 resuming into the power-on mode to the time that the Bluetooth connection CON between the remote controller device 120 and the host terminal 140 is successfully re-established), the processing unit 124 keeps executing the step S212 to temporarily record the received key-input information INkey in the buffer memory 126.

In one embodiment, the key-input information INkey includes one or more key codes generated according to different keys pressed by the user. For example, the key module 128 includes a sound volume increase key, a sound volume decrease key, a mute key, a home key, a switch key, directional keys, execute/cancel keys, and the like. The key code corresponding to the sound volume increase key can be 0x0A, the key code corresponding to the sound volume decrease key can be 0x0B, the key code corresponding to the mute key can be 0x0C, the key code corresponding to the home key can be 0x0D, and the key code corresponding to the switch key can be 0x0E. In addition, the key-input information INkey can include the key press counts of the key codes and the pressing sequence of the key codes.

It should be noted that temporarily recording the key-input information INkey in the lasting time DUR in the buffer memory 126 is capable of avoiding the loss of the key information generated by the user pressing in this duration, and then preventing the user from assuming the key operation failing to improve the operation experience of the user.

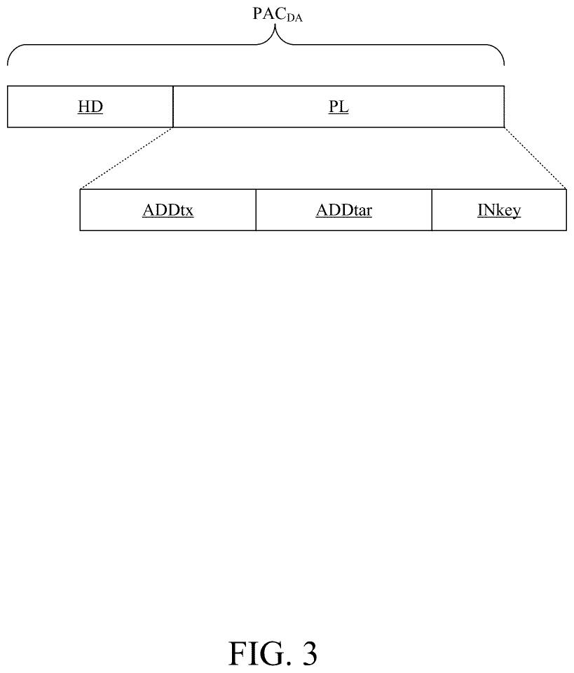

As shown in FIG. 1 and FIG. 2, the processing unit 124 executes the step S213 to attach the key-input information INkey temporarily recorded in the buffer memory 126 to the payload of the re-connection advertising packet PAC_{DA}. Reference is made to FIG. 3, which is a schematic diagram illustrating the packet content of the re-connection advertising packet PAC_{DA} according to some embodiments of the disclosure.

As shown in FIG. 3, the re-connection advertising packet PAC_{DA} includes a packet header HD and a payload PL. In one embodiment, in the step S213, the processing unit 124 attaches the key-input information INkey to the tail of the payload PL. As shown in FIG. 3, the payload PL of the re-connection advertising packet PAC_{DA} includes an initiator address ADDtx of the remote controller device 120, a advertising target address ADDtar corresponding to the host terminal 140 and the key-input information INkey. As shown in FIG. 3, the byte for recording the key-input information INkey in the payload PL follows those for recording the initiator address ADDtx and the advertising target address ADDtar.

As shown in FIG. 1 and FIG. 2, the Bluetooth communication circuit 122 executes the step S214 to transmit the re-connection advertising packet PAC_{DA}, and the re-connection advertising packet PAC_{DA} is configured to trigger re-establishing of the Bluetooth connection CON between the remote controller device 120 and the host terminal 140.

Compared to the typical re-connection advertising packet, the key-input information INkey is attached to the tail of the payload PL of the re-connection advertising packet PAC_{DA} in this disclosure. Therefore, the re-connection advertising packet PAC_{DA} carries the key-input information INkey corresponding to the operation of the user in the lasting time DUR. When receiving the re-connection advertising packet PAC_{DA}, the host terminal 140 can analyze the re-connection advertising packet PAC_{DA} to obtain the key-input information INkey, and respond to the operation of the user with waiting for the re-establishing of the Bluetooth connection CON.

Afterward, the Bluetooth communication 122 and the processing unit 124 of the remote controller device 120 execute the step S215 to judge if the re-connection is successful or not, and execute the step S216 to re-establish the Bluetooth connection CON if the re-connection is successful (e.g., receiving the connection request packet replied by the host terminal 140). The key-input information generated by the remote controller device 120 after the lasting duration DUR can be transmitted to the host terminal 140 through the Bluetooth connection CON.

It should be noted that after the re-establishing of the Bluetooth connection CON, the remote controller device 120 does not resend the key-input information INkey generated in the lasting duration DUR. Since the key-input information INkey in the lasting duration DUR has been transmitted through the re-connection advertising packet PAC_{DA}, the remote controller device 120 does not resend the key-input information INkey to avoid the operation confusion occurring on the host terminal 140.

Besides, if there are serious ambient noises in the surrounding, it may cause that the re-connection is judged as failing in the step S215 (e.g., continuously failing to receive the connection request packet replied by the host terminal 140), and then the step S217 is executed for the processing unit 124 to judge if the re-connection time exceeds a time limit. If the re-connection time is judged as not exceeding the time limit (e.g., trying the re-connection less than 10 seconds), the step S214 is executed again for the Bluetooth communication circuit 122 to continuously transmit the re-connection advertising packet PAC_{DA}. If the re-connection is judged as exceeding the time limit (e.g., trying the re-connection over 10 seconds), the processing unit 124 can judge that the re-connection fails.

It should be noted that no matter the re-connection is successful and the Bluetooth connection CON is successfully established or not, the re-connection advertising packet PAC_{DA} would transmit the key-input information INkey in the lasting duration DUR to the host terminal 140. As long as the host terminal 14 can receive the re-connection advertising packet PAC_{DA}, it can respond to the key-input information INkey in real time.

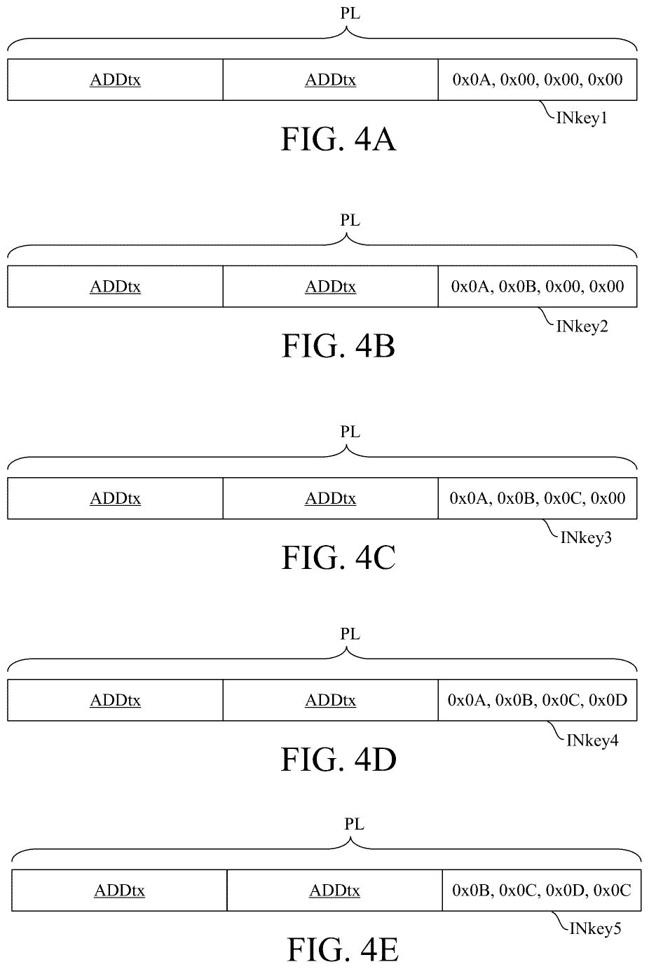

Reference is made to FIG. 4A to FIG. 4E, which are schematic diagrams respectively illustrating various key-input information INkey1˜INkey5, corresponding to different keys pressed by the user, carried by the re-connection advertising packet PAC_{DA}. As shown in the embodiments of FIG. 4A to FIG. 4E, the key-input information INkey1˜INkey5 are assumed as respectively including four bytes for sequentially storing four key codes. It means that the maximum quantity for temporarily recording the key codes is four (i.e., the maximum quantity of the key code being temporarily recorded of the buffer memory 126 is four).

As shown in FIG. 4A, it assumes that the user presses the sound volume increase key once. At this time, the first byte of the key-input information INkey1 in FIG. 4A records 0x0A, and the following three bytes still maintain 0x00.

As shown in FIG. 4B, it assumes that the user presses the sound volume increase key once and the sound volume decrease key once. At this time, the first two bytes of the key-input information INkey2 in FIG. 4B record 0x0A and 0x0B, and the following two bytes still maintain 0x00.

As shown in FIG. 4C, it assumes that the user presses the sound volume increase key once, the sound volume decrease key once and the mute key once. At this time, the first three bytes of the key-input information INkey3 in FIG. 4C record 0x0A, 0x0B and 0x0C, and the fourth byte still maintains 0x00.

As shown in FIG. 4D, it assumes that the user presses the sound volume increase key once, the sound volume decrease key once, the mute key once and the home key once. At this time, the four bytes of the key-input information INkey4 in FIG. 4D sequentially record 0x0A, 0x0B, 0x0C and 0x0D.

As shown in FIG. 4E, it assumes that the user presses the sound volume increase key once, the sound volume decrease key once, the mute key once, the home key once, and presses the mute key once again. At this time, the amount of the key codes temporarily recorded in the lasting time DUR is five exceeding the maximum quantity (assumed as four), and then the processing unit 124 would discard the key code recorded at the earliest in the buffer memory 126, where the key code of the sound volume increase key would be discarded. As shown in FIG. 4E, the four bytes of the key-input information INkey5 sequentially record 0x0B, 0x0C, 0x0D and 0x0C, and then the key-input information INkey5 represents sequentially pressing the sound volume decrease key once, the mute key once, the home key once and the mute key once again.

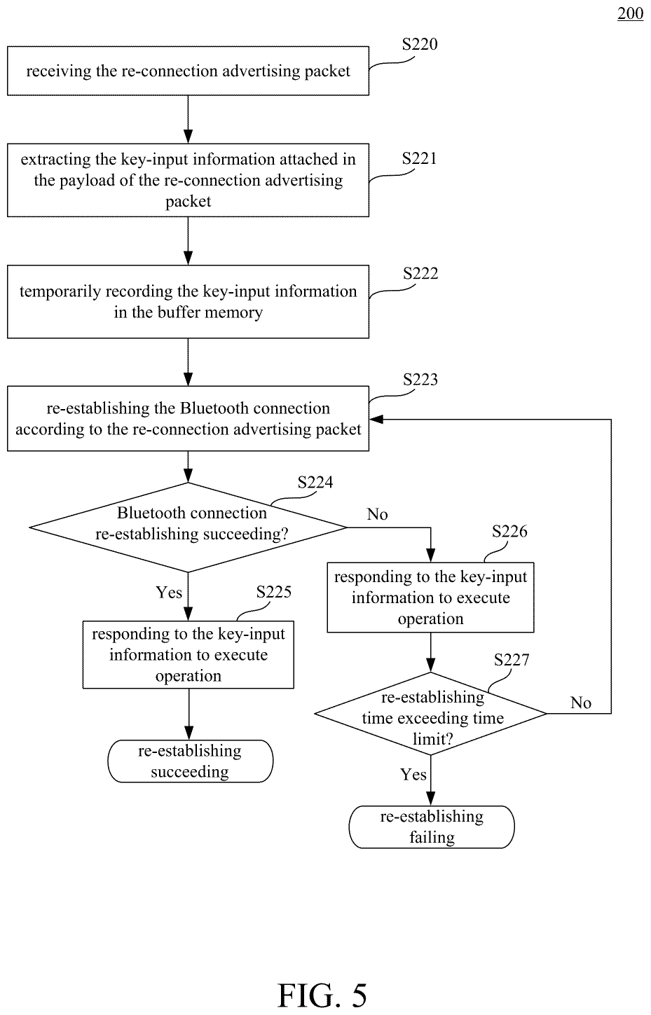

Reference is made to FIG. 5, which is a flow chart illustrating steps S220 to S227 executed by the host terminal of a Bluetooth communication method 200 according to the disclosure. The steps S220 to S227 in FIG. 5 can be executed by the host terminal 140 in FIG. 1.

As shown in FIG. 1 and FIG. 5, the Bluetooth communication circuit 142 of the host terminal 140 executes the step S220 to receive the re-connection advertising packet PAC_{DA}. The processing unit 144 of the host terminal 140 executes the step S221 to extract the key-input information INkey (referring to the key-input information INkey1˜INkey5 in FIG. 4A to FIG. 4E) attached to the payload PL of the re-connection advertising packet PAC_{DA}.

In one embodiment, as shown in FIG. 1 and FIG. 5, the processing unit 144 of the host terminal 140 executes step S222 to temporarily record the key-input information INkey in the buffer memory 146 of the host terminal 140. The processing unit 144 and the Bluetooth communication circuit 142 of the host terminal 140 execute the step S223 to re-establish the Bluetooth connection CON according to the re-connection advertising packet PAC_{DA} (the initiator address of the remote controller device 120 recorded therein). Afterward, the processing unit 144 and the Bluetooth communication circuit 142 of the host terminal 140 execute the step S224 to judge if the Bluetooth connection CON is successfully re-established. Afterward, no matter the host terminal 140 successfully establishes the Bluetooth connection CON with the remote controller device 120 or not, the host terminal 140 executes the step S225 or the step S226 to execute the corresponding operation according to the key-input information INkey in the re-connection advertising packet PAC_{DA}.

For example, when the key-input information INkey includes the key code of 0x0A, the host terminal 140 increases the sound volume of the speaker 148; when the key-input information INkey includes the key code of 0x0B, the host terminal 140 decreases the sound volume of the speaker 148; when the key-input information INkey includes the key code of 0x0C, the host terminal 140 mutes the speaker 148; when the key-input information INkey includes the key code of 0x0D, the host terminal 140 enable the display panel 149 to display the home menu; when the key-input information INkey includes the key code of 0x0E, the host terminal 140 temporarily switches off the speaker 148 and the display panel 149.

As shown in FIG. 1 and FIG. 5, after the step S226, the processing unit 144 can execute the step S227 to judge if the time for trying re-establishing exceeds a time limit. If the time is judged as not exceeding the time limit, the step S223 is executed again to continuously try to re-establish the Bluetooth connection CON. If the time is judged as exceeding the time limit, the processing unit 144 can judge that the re-establishing of the Bluetooth connection CON fails.

In another embodiment, the processing unit 144 of the host terminal 140 can pass the steps S222 to S224 and directly respond to the key-input information INkey in the re-connection advertising packet PAC_{DA} to execute the corresponding operation after the extracting of the step S221.

As aforementioned, in the application scenario requiring real-time response, the host terminal 140 can execute the corresponding operation according to the key-input information INkey in the re-connection advertising packet PAC_{DA}, without waiting for the re-establishing of the Bluetooth connection CON, so as to reduce the response time of the host terminal 140 and improve the operational fluency for the user.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A Bluetooth communication method, suitable for a remote controller device, the remote controller device being configured to be Bluetooth-paired with a host terminal, the Bluetooth communication method comprising:
in a lasting duration since the remote controller device resumes from a power-off mode into a power-on mode and the remote controller device does not re-establish a Bluetooth connection with the host terminal yet, temporarily recording a key-input information generated by the remote controller device in a buffer memory of the remote controller device;
attaching the key-input information in the buffer memory to a payload of a re-connection advertising packet; and
transmitting the re-connection advertising packet, and the re-connection advertising packet being configured to trigger re-establishing of the Bluetooth connection between the remote controller device and the host terminal.

2. The Bluetooth communication method according to claim 1, wherein the payload of the re-connection advertising packet comprises an initiator address corresponding to the remote controller device, an advertising target address corresponding to the host terminal, and the key-input information.

3. The Bluetooth communication method according to claim 2, wherein a byte for recording the key-input information in the payload follows those for recording the initiator address and the advertising target address.

4. The Bluetooth communication method according to claim 1, wherein after the re-establishing of the Bluetooth connection between the remote controller device and the host terminal, the remote controller device does not resend the key-input information in the lasting duration.

5. The Bluetooth communication method according to claim 1, wherein the key-input information comprises at least one key code.

6. The Bluetooth communication method according to claim 5, wherein the key-input information further comprises at least one key press count corresponding to the at least one key code.

7. The Bluetooth communication method according to claim 5, wherein the buffer memory has a maximum quantity of the key code being temporarily recorded, and the Bluetooth communication method further comprises:
discarding the key code recorded at the earliest in the buffer memory when the quantity of the at least one key code temporarily recorded in the lasting duration exceeds the maximum quantity.

8. A remote controller device, comprising:
a Bluetooth communication circuit, configured to Bluetooth-pair the remote controller device and a host terminal;
a buffer memory:
a key module; and
a processing unit, coupled to the Bluetooth communication circuit, the buffer memory and the key module,
wherein in a lasting duration since the remote controller device resumes from a power-off mode into a power-on mode and the remote controller device does not re-establish a Bluetooth connection with the host terminal yet, the processing unit temporarily records a key-input information generated by the key module in the buffer memory, the processing unit attaches the key-input information in the buffer memory to a payload of a re-connection advertising packet, and the Bluetooth communication circuit is configured to transmit the re-connection advertising packet, the re-connection advertising packet is configured to trigger re-establishing of the Bluetooth connection between the remote controller device and the host terminal.

9. The remote controller device according to claim 8, wherein the payload of the re-connection advertising packet comprises an initiator address corresponding to the remote controller device, an advertising target address corresponding to the host terminal, and the key-input information.

10. The remote controller device according to claim 9, wherein a byte for recording the key-input information in the payload follows those for recording the initiator address and the advertising target address.

11. The remote controller device according to claim 8, wherein after the re-establishing of the Bluetooth connection between the remote controller device and the host terminal, the remote controller device does not resend the key-input information in the lasting duration.

12. The remote controller device according to claim 8, wherein the key-input information comprises at least one key code.

13. The remote controller device according to claim 12, wherein the key-input information further comprises at least one key press count corresponding to the at least one key code.

14. The remote controller device according to claim 12, wherein the buffer memory comprises a maximum quantity of the key code being temporarily recorded, and when the quantity of the at least one key code temporarily recorded in the lasting duration exceeds the maximum quantity, the processing unit discards the key code recorded at the earliest in the buffer memory.

15. A Bluetooth communication method, suitable for a wireless communication system comprising a host terminal and a remote controller device Bluetooth-paired with each other, the Bluetooth communication method comprising:
in a lasting duration since the remote controller device resumes from a power-off mode into a power-on mode and the remote controller device does not re-establish a Bluetooth connection with the host terminal yet, the remote controller device temporarily recording a key-input information generated by the remote controller device in a buffer memory of the remote controller device;
the remote controller device attaching the key-input information in the buffer memory to a payload of a re-connection advertising packet;
the remote controller device transmitting the re-connection advertising packet, and the re-connection advertising packet being configured to trigger re-establishing of the Bluetooth connection between the remote controller device and the host terminal;
the host terminal receiving the re-connection advertising packet;
the host terminal re-establishing the Bluetooth connection with the remote controller device according to the re-connection advertising packet; and
the host terminal executing a corresponding operation according to the key-input information attached to the payload of the re-connection advertising packet.

16. The Bluetooth communication method according to claim 15, wherein the host terminal executes the corresponding operation according to the key-input information no matter the host terminal successfully re-establishes the Bluetooth connection with the remote controller device or not.
